(19) United States
(12) Patent Application Publication
(10) Pub. No.: US 2013/0013391 A1
(43) Pub. Date: Jan. 10, 2013

(54) Dynamic Frequency Capping with Escalating Offers

(76) Inventors: Mark Douglas, Marina Del Rey, CA (US); Kevaughn Bullock, South Pasadena, CA (US); Takuju Ueda, Rancho Palos Verdes, CA (US)

(21) Appl. No.: 13/176,659

(22) Filed: Jul. 5, 2011

(51) Int. Cl. G06Q 30/00

(52) U.S. Cl. 705/14.39

(57) ABSTRACT

There is disclosed a system and method for dynamic frequency capping with escalating offers. The method includes accessing a user identification system to uniquely identify a user and an offer database to identify an offer campaign to be presented to the user. The method then includes determining that the number of times that a first offer has been presented to the user has exceeded a threshold associated with the first offer or that the user has declined a first offer, accessing the offer database to identify an alternative offer to be presented to the user and presenting the alternative offer to the user. The alternative offer may represent enhanced value over the first offer. A counter is incremented in the offer database associated with a number of views of the alternative offer by the user.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to online offers and specifically to dynamic frequency capping with escalating offers.

2. Description of the Related Art

Online advertisement continues to grow as Internet users spend increasing time consuming web-based content. In efforts to curtail spending on advertisements, advertisers have sought to place frequency caps on the total number of times an advertisement is shown to users. These caps may take the form of a total allowed advertising spend in dollars or a total number of advertisements displayed. Still other solutions have capped the total number of times a particular advertisement is shown to a given user. In these way, an advertiser can have some control over the total cost of the advertising and be assured that the desired advertisement will be made to a specific number of users.

### DESCRIPTION OF THE DRAWINGS

FIG. 1 is a diagram of a computer network.

FIG. 2 is a diagram of a computing device.

FIG. 3 is a diagram of a system for dynamic frequency capping and escalating offers.

FIG. 4 is a flowchart of dynamic frequency capping with escalating offers.

FIG. 5 is a flowchart of offer and threshold creation.

Throughout this description, elements appearing in figures are assigned three digit reference designators, where the most significant digit is the figure number where the element is introduced and the two least significant digits are specific to the element. An element that is not described in conjunction with a figure may be presumed to be the same as a previously-described element having the same reference designator.

### DETAILED DESCRIPTION

Description of Apparatus

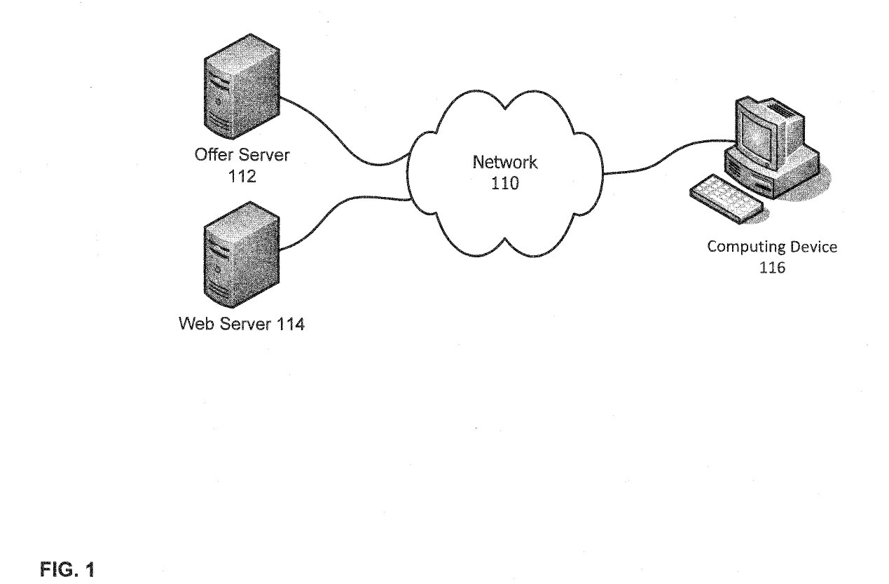

Referring now to FIG. 1, a network 110 is shown. An offer server 112, a web server 114 and a computing device 116 are attached to the network 110.

The network 110 may take the form of a local network, a wide area network, the Internet or any number of other networks. The network 110 may be implemented locally by physically connected computers or may be distributed over a wide area.

The offer server 112 provides offers to the computing device 116 upon receipt of offer requests. One offer server 112 is shown, but the offer server 112 may one or more servers capable of providing offers. The offer server 112 may include one or more processors.

The web server 114 serves web pages to the computing device 116. The web server 114 may access or utilize the offer server 112 to provide offers to the computing device 116 when web pages are requested.

The computing device 116 is connected to the network. The computing device 116 is shown as a computer, but may take many forms. The computing device 116 may be a mobile device, a tablet PC, a personal digital assistant, a smart phone, a “dumb” phone, a feature phone, a server computer operating as a part of a distributed or peer-to-peer network or many other forms.

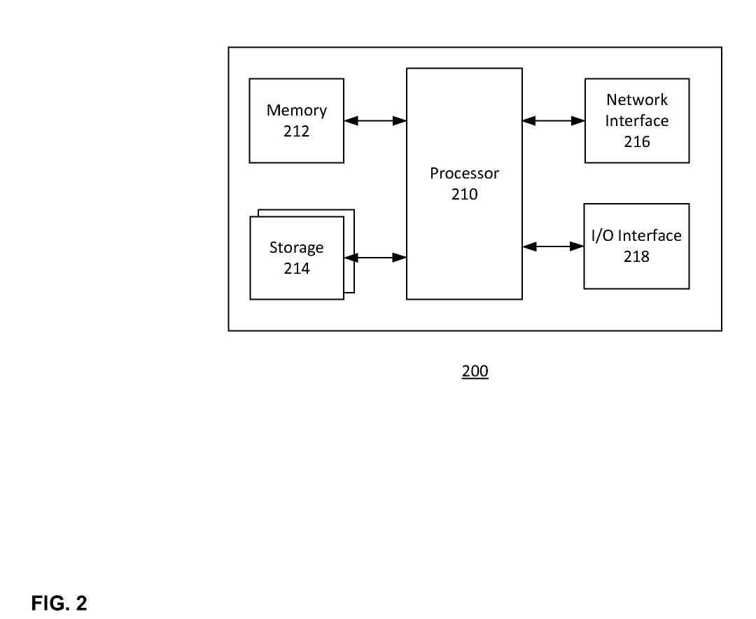

Turning now to FIG. 2 there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, field programmable gate arrays (FPGAs), application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage.

The network interface 216 includes an interface to a network such as network 110 (FIG. 1).

The I/O interface 218 interfaces the processor 210 to peripherals (not shown) such as displays, keyboards and USB devices.

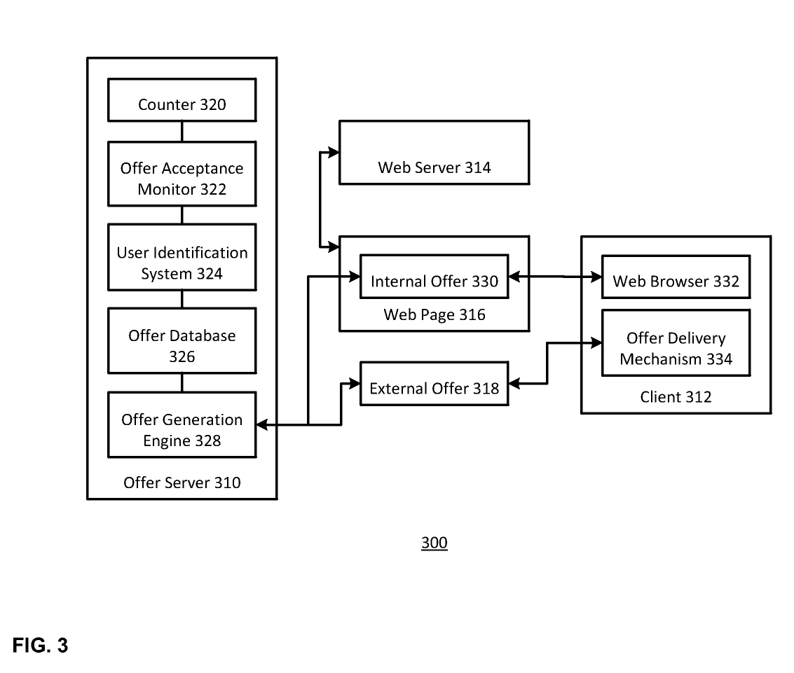

Turning now to FIG. 3, a diagram of a system 300 for dynamic frequency capping and escalating offers is shown. The system 300 includes an offer server 310, a client 312, a web server 314 serving a web page 316, and an external offer 318. The offer server 310 includes a counter 320, an offer acceptance monitor, a user identification system 324, an offer database 326 and an offer generation engine 328. The client 312 includes a web browser 332 and an offer delivery mechanism 334. The web page 316 may incorporate an internal offer 330.

The offer server 310 is a server designed to provide offers. The offer server 310 may provide advertisements or other offers in response to requests to do so. The offer server incorporates a number of elements. The first is a counter 320 that is used to count the number of times an offer is presented to a particular user.

The offer server 310 also includes an offer acceptance monitor 320 that determines whether or not an offer made to a user has been accepted. The offer server 310 also includes a user identification system 324 for identifying a particular user. This user identification system 324 may be used by the offer acceptance monitor 320 in order to identify a user before determining that an offer has or has not been accepted.

The offer server 310 also includes an offer database 326 that stores the various offers and the rules associated with those offers. For example, the offer database 326 may include a rule that states that a particular offer is only to be shown 5 times to a particular user, then, a second offer is to be shown 5 times to that user, then a third offer is to be shown 15 times to a user and, then, a default offer is to be shown after that.

The offers server 310 also includes an offer generation engine 328 that utilizes the user identification system 322 and the rules in the offer database 326 to generate offers in response to requests to do so. The user identification system 324 may utilize a tracking pixel or the capability to generate system signatures in order to uniquely identify users. System signature systems analyze the composition of a user's hardware and software components and utilize those to generate a unique identification for the user. The user identification system 324 may store data pertaining to each unique user so that it may identify users without reference to data stored on a user's computer such as a cookie.

The offer generation engine 328 has access to the offer database 326. The offer database 326 may include text offers, display offers or other types of offers that may be provided to a user. These offers also may be hosted on the web server 314 or by a service (not shown) designed to provide high availability to content.

The client 312 is representative of a user operating a device upon which offers may be made. The client 312 may be a personal computer, a mobile phone, a thin client, a television with web access or a similar device. The client 312 includes at least one of a web browser 332 or another offer delivery mechanism 334. The web browser 332 is a typical web browser capable of displaying hypertext markup language and other web-based content.

The offer delivery mechanism 334 may include email messages; sms texts; dynamic in-email offers displayed when the email is viewed; in-application advertisements (for example, in smartphone applications); audio advertisements via the web, radio or streaming radio; and video advertisements embedded in web-based television, streaming video, or purchased or rented video viewed on the client 312. The offer delivery mechanism 332 need only be capable of relaying offers to users and providing information to the offer server so that it may calculate the total number of times the offer has been delivered to a particular user.

The web server 314 is a typical web server or web servers capable of serving web content for viewing in a web browser 332. The web server 314 may also serve related content such as streaming audio, video, images and other associated media. The web server 314 may in fact be implemented on a plurality of web servers or a distributed server farm offering high accessibility.

The web server 314 serves web pages like web page 316 which may include offers like internal offer 330. The internal offer 330 is only “internal” because it is integrated into a web page 316 viewed by a web browser 332. The external offer 318 is only “external” because it is separate and apart from a web page 316. The external offer 318 may take the form of an offer integrated into the offer delivery mechanism 334 described above.

Description of Processes

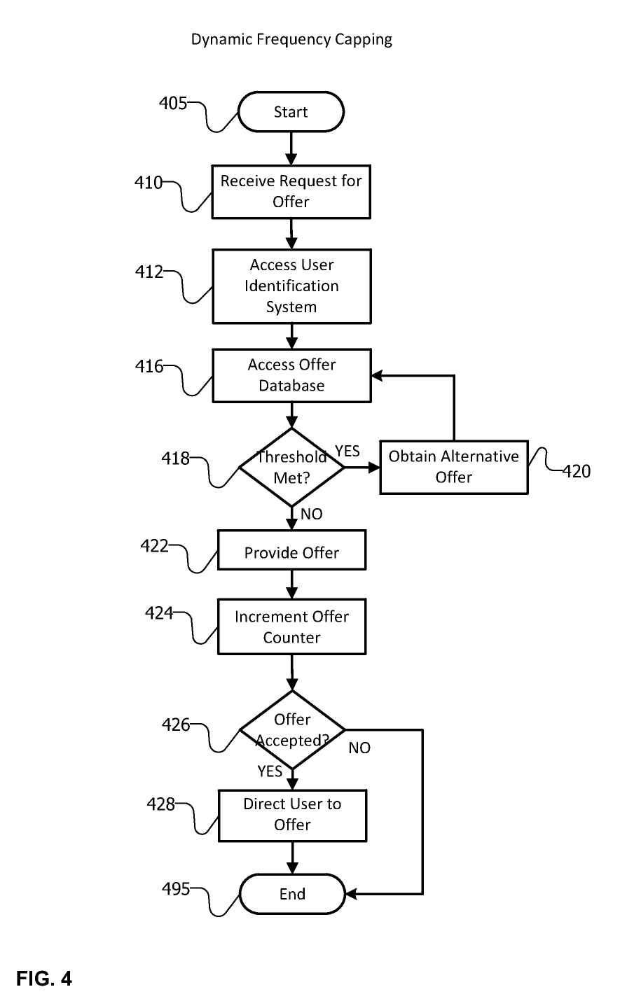

Turning now to FIG. 4, a flowchart of dynamic frequency capping with escalating offers is shown. The methods and processes described may be carried out on the system of FIG. 3.

As a user is navigating a web page or using a mobile application, for example, on a smartphone, a request for an offer is received at 410. This request is made by a web server and may be prompted by a user's visit to a web page serviced by the web server. As a result of that visit, an embedded link to an offer server, such as offer server 310 may be generated. Alternatively, the offer server may be a part of a web server serving web pages to the user. The request for an offer asks the offer server to provide an offer to a user. The request may be prompted by launching of or other use of a mobile application.

As a part of that request, identifying information available to the web server or mobile application regarding the user is also provided to the offer server 310. Alternatively, the user is directed to the offer server 310 and the offer server 310 obtains identifying information regarding the user.

The identifying information is used by the offer server to access the user identification system at 412 and to, thereby, uniquely identify a user. This identifying information may include the user's internet protocol address, MAC address, information gathered from other websites that the user has visited, internet service provider data, self-identified data and various other types of identifying information. The identifying information is used by the user identification system to obtain the identity of a user with some degree of certainty.

Once the identity of the user is known, the offer database is accessed at 416. The offer server is a database of offers to be presented to users. Using the identity information, an offer database, such as offer database 326, may determine whether and how many times a given user has been presented with a particular offer at 416. The offer database may also determine whether any other threshold has been met. The offer database may provide various other functionality such as identifying a relevant advertisement for the user.

Next, a determination is made at 418 as to whether a threshold associated with the offer has been met for the particular user. The thresholds may be the number of times, frequency, or prominence of an offer presented to a user. The thresholds may be user-based or may be based upon total views of an offer, total conversions on an offer or any number of other values related to the offer. In some instances, the threshold may be a single presentation of the offer, after which the offer may be altered or enhanced. Thresholds may also be in the form of expressions based upon known user information, such as recent product searches, prior responses to alternative offers and other data.

If the threshold is not met, then the offer will be provided to the user at 422. Next, a counter associated with the offer and the user is incremented at 424 so that the next time that user appears it can be determined again whether or not a threshold associated with that offer and user combination has been met.

If the threshold has been met, an alternative offer may be obtained at 420. In this case, the offer database is accessed again at 416 to determine the next offer to be presented to the user. This alternative offer may be a next offer in line in a group of related offers or may be a completely distinct offer, unrelated to the prior offer and including its own thresholds. This alternative offer may have its own thresholds or it may have no threshold. Some offers may be used as “default” offers, lacking any threshold, once all offers with thresholds have been made.

The alternative offer obtained at 420 may, for example, be one in a series of offers related to an online music shop. This series may first offer a user a set of drums, then a guitar, then guitar strings and then a public address system. These offers are related, alternative offers for one music shop. Each offer may have a threshold of a single viewing by a given user or a threshold of total views for all users per offer. Completely unrelated offers may be made in series as alternative offers. Initial and alternative offers may be based in part upon information pertaining to the user to whom the offer will be made.

Alternative offers may appear on a single set of web pages or on unrelated web pages, each serviced by the same offer server or set of offer servers. Each offer is generated in response to a request directed to the offer server. As the user navigates through any web pages serviced by the offer server, a set of alternative offers may be made to the user. The offer server is capable of this because it maintains a database and user identification system distinct from an individual web server. The offer server serves offers for use on any number of web servers. As the user navigates from page to page, he or she is identified at each of those pages by the user identification system and additional offers may be made to that user.

Other data available to the offer server may also be used in order to select an offer to be made to the user. For example, if the offer server includes data regarding the recent web browsing history of the user, then the offer server may select an alternative offer based upon the user's recent web searches or viewing activity on web pages offering shoes.

The alternative offer obtained at 420 may be an escalated offer of enhanced value. Enhanced value is an increase in perceived or actual value to a user. Discounts in real or percentage terms on products or services are examples of enhanced value. Free or reduced cost gifts, shipping, warranties, extended warranties, extra products and extra services are also examples of enhanced value. Paying all or a portion of taxes associated with the sale of a product or service is another example of enhanced value.

The thresholds associated with an escalated offer may be numbers, expression-based total views of an offer or any other threshold. In many cases, the threshold may be one view per user. In some cases, the same offer may be presented a number of times before an escalated offer is presented. In others, the user's data may be associated with the threshold, for example, only providing the escalated offer after three views because the user has previously demonstrated a willingness to accept escalated offers after three views.

An escalated offer itself may also be based upon information pertaining to the user's identity. Data associated with a user's identity may indicate that prior conversions occurred as a result of a “free shipping” offer, for example. An escalated offer may be framed in the form of an expression such that the first escalation is to offer free shipping because a user has previously responded to those types of offers. This expression may be based upon data associated with the user. In this way, an if/then or case style statement may be used as the form of the offer escalation either in selecting priority for escalation of offers for a particular use, in determining whether to proceed directly to particular offers or in avoiding particular offers.

At some point, set by the entity making the offer, all escalated offers may have been offered to the user. This may be, for example, after three escalations presenting increasing enhanced value, Offers may be dynamic up to a certain threshold value. For example, a user may receive offers of increasing discounts up to 45% in increments of 5%, but once 45% is reached, the escalating offers will stop.

An entity providing escalating offers may set parameters related to their escalation using expressions indication percentage or absolute price discounts, increments by which the offer is escalated, and other parameters such as shipping, free gift products, additional time or services and other similar escalations. For example, a user may be provided with a first offer of free shipping, then free shipping plus a discount, then free shipping plus a discount and an additional bonus product.

From the user's perspective, the user navigates to a web page that is serviced by the offer server. An offer is made on that web page (i.e. for free shipping if shoes are purchased by clicking the offer). The user declines the offer and proceeds to a second web page. The second web page may or may not be on the same web site. On the second web page, an escalated offer is made to the user (i.e. for free shipping and a 10% discount). The user still declines the offer and navigates to a third web page. A third escalated offer is presented to the user on that page (i.e. for free shipping, 10% discount and a free pair of sandals). Finally, the user accepts the offer, clicks the link sending the user to the web page associated with the offer and purchases a product associated with the offer.

When obtaining the alternative offer at 420, the offer database is accessed again at 416. However, the offer database 310 now includes data from a prior interaction with that user indicating that one or more prior offers were made to this user and not accepted. Because of these prior offers, the offer database will identify an alternative offer which may be an escalated offer. At 418, if it is determined that no threshold regarding the alternative offer has been met, the alternative offer is then provided to the user at 422. A counter regarding the alternative offer and the user is incremented at 424.

The system monitors to determine whether or not the alternative offer is accepted at 426. This determination may be made, for example, based upon conversion information. Whenever a click-through sale is made, the referring site is credited with the click-through. Resulting sales are called conversions and are also credited to the referring site. In this way, a lack of response in the form of a click through or conversion is an indication that the user has not accepted the offer and a response in one of these forms is an indication of acceptance of the offer.

The failure to accept may be navigating away from a web page featuring the offer without clicking on it or may be a timeout of the offer after a few seconds demonstrates a lack of acceptance. The information pertaining to a failure to accept may be noted by the system as relevant information pertaining to the user for future use in selecting offers to be presented to the user.

If the offer is accepted at 426, then the system will direct the user to a web address or provide another means by which the subject matter of the offer may be completed by the user at 428. The acceptance may be noted in the information stored regarding a user as relevant information for future use in selecting other offers for that user.

If the user has failed to accept the offer at 426, then the process ends. If additional requests are made further alternative offers maybe obtained in much the same way as the first. If a user fails to accept any of the alternative offers, a default offer may be presented to the user if there are still further additional requests 410. This is done by accessing the user identification system 412 to confirm that the user has previously been presented with the escalating offer set and has not responded. The default offer may or may not be associated with the escalating offer or the entity making the escalating offer.

Alternatively, a different set of escalating offers may be presented to the user in response to additional requests. Additional requests may be identified wherein a user visits another page serviced by the offer server 310. If an additional request is received, the user identification system 324 is accessed again at 412 and the entire process begins anew.

The flow chart has both a start 405 and an end 495, but the process may be cyclical in nature. Portions of the process may be accomplished in parallel or serially. Multiple instances of the process may be taking place in parallel or serially.

For example, this process may take place such that a given user may only be presented with a first offer a total of five times. The same user may only be presented with a second offer until a third day of presenting it has elapsed. The first and second offers may or may not be related to one another and may or may not be created by the same entity, such as an advertiser, retailer or other offer provider.

The thresholds associated with an offer campaign may be total number of times each offer is presented to a user. Alternatively, thresholds may be a number of days that an offer may be presented to a user, a total number of page views, a total number of conversions, or any other variable available to the offer server and associated with the user. The thresholds may be complex expression-like thresholds that require an offer to be presented a set number of times if the user has viewed more than a set number of web pages related to a particular product within a predetermined number of days. If a threshold of this type is not met, then the next offer or default offer may be provided to the user.

The entity requesting the offer may set the threshold. In this way, the entity, such as an advertiser, can indicate that it wishes for a particular offer to be seen by a user a maximum number of times. If a user has not responded to the offer in that time, then the user may be deemed by an entity as unlikely to do so. In this way, it may be best to present that user with a different offer. The same or a second entity may then identify a different offer with its own threshold. An entity may alter the threshold associated with an offer as desired.

Once the threshold associated with both offers has been met for a given user, then the user may be presented with a third offer, the third offer associated with a third threshold. Instead, a number of “default” offers may also be available. These default offers may not have any thresholds associated with them and may be shown to users any number of times. Instead, a new set of offers, each with their own associated thresholds may be shown to the user.

Offers, alternative offers and default offers may be arranged in campaigns. Offer campaigns are a group of multiple offers, each with their own thresholds that are to be provided to a given user. Using campaigns, a first offer may be presented to a user for three days, a second offer may be presented to a user a total of four times, a third offer may be presented to a user until the user's total page views reach a predetermined limit and, thereafter, a default offer may be presented to the user. In some instances, the first offer, with its own threshold, may be the same as the third offer, with a different or identical threshold.

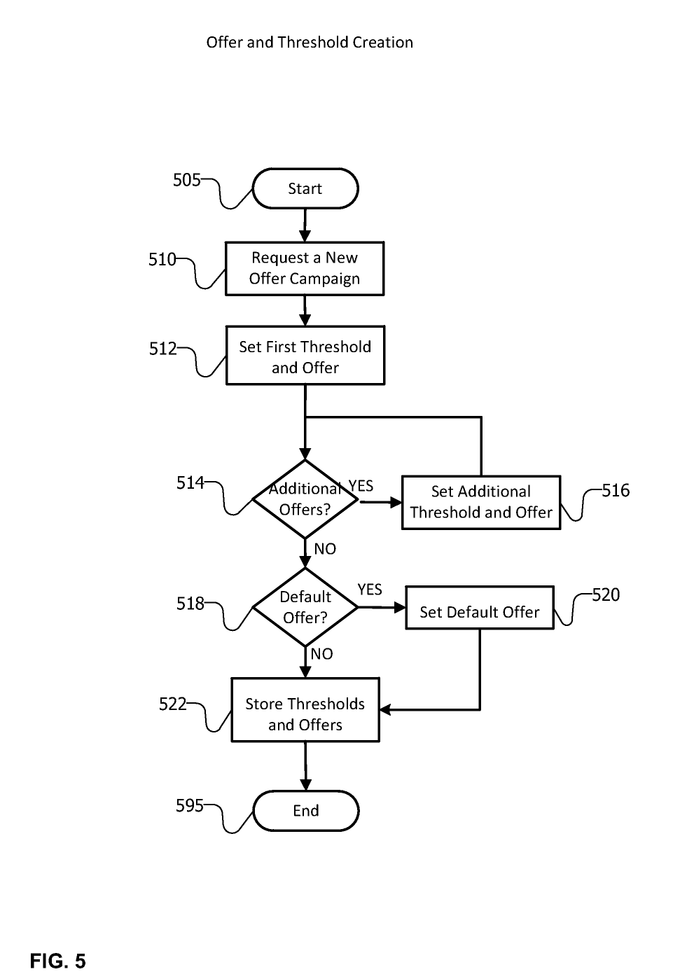

Turning now to FIG. 5, a flowchart of offer and threshold creation is shown. This is the process undertaken by an offering entity in creating its offers with dynamic threshold caps. The process begins at 505 when a user determines to create a new offer campaign. First, the offering entity requests a new offer campaign at 510. The campaign may be a single offer or may be a series of offers.

The offering entity then sets a first threshold and offer at 512. At this stage, the offering entity provides the offer server with a first offer to be made to user and an associated threshold. Next, the offering entity must determine if there are additional offers at 514 If so, the user sets an additional threshold and offer 516 associated with the first. This additional offer will be provided to a user once the first threshold has been met in place of the first offer.

The user may again determine if there are to be additional offers at 514. If so, the user may, again, set an additional threshold and offer at 516. If not, or once all additional offers and thresholds have been set, the offering entity may choose to input a default offer at 518. This default offer may be shown to users after each of the previous associated thresholds and offers have been met. If a default off is desired, it is set at 520.

Once each of the thresholds and offers are set, they are stored at 522. The offer server 310 (FIG. 3) can begin making the offers to users of sites serviced by the offer server 310.

For example, the offering entity may create a new offer campaign related to a particular product or group of products. The offering entity may wish to provide three offers in turn to a user. The first offer may be for a pair of shoes, the second offer may be for a better pair of shoes, the third offer may be a default offer generally promoting the site selling shoes.

The threshold associated with the first offer may be two views of the offer by a given user. The threshold associated with the second offer may be three views, so long as the user has more than 15 page views including the word “shoes” in the last two weeks. The process ends at 595 when the user has completed input of the offer campaign.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for presenting offers to users comprising:
accessing a user identification system to uniquely identify a user;
accessing an offer database to identify an offer campaign to be presented to the user, the offer campaign including a first offer, a first threshold, an alternative offer and an alternative threshold;
determining that the user has declined the first offer and that the first threshold has been exceeded;
accessing the offer database to identify the alternative offer in the campaign to be presented to the user;
presenting the alternative offer to the user; and
incrementing a counter associated with the alternative threshold.

2. The method of claim 1 wherein one of the first threshold and alternative threshold is an expression used to obtain a binary response regarding a user.

3. The method of claim 1 wherein the first threshold is one of a type selected from the group consisting of a total number of views by the user, a total number of days the first offer has been seen by the user, a total number of page views by a user, and a total number of conversions by a user.

4. The method of claim 1 further comprising:
presenting the alternative offer to the user until the alternative threshold has been met;
accessing the offer database to identify a second alternative offer and a second alternative threshold;
presenting the second alternative offer to the user; and
incrementing a second counter associated with the second alternative threshold.

5. The method of claim 4 wherein the second alternative offer is a default offer, the default offer not associated with any threshold.

6. The method of claim 1 wherein the first offer is associated with the alternative offer and the alternative offer represents an enhanced value over the first offer.

7. The method of claim 6 further comprising:
determining that the user has declined the alternative offer;
accessing the offer database to identify a second alternative offer associated with and representing enhanced value over the first offer and the alternative offer; and
presenting the second alternative offer to the user.

8. An apparatus for presenting offers to users comprising an offer server for:
accessing a user identification system to uniquely identify a user;
accessing an offer database to identify an offer campaign to be presented to the user, the offer campaign including a first offer and an alternative offer;
determining that the user has declined the first offer;
accessing the offer database to identify the alternative offer in the campaign to be presented to the user;
presenting the alternative offer to the user; and
incrementing a counter associated with the alternative threshold.

9. The apparatus of claim 8 wherein one of the first threshold and alternative threshold is an expression used to obtain a binary response regarding a user.

10. The apparatus of claim 8 wherein the first threshold is one of a type selected from the group consisting of a total number of views by the user, a total number of days the first offer has been seen by the user, a total number of page views by a user, and a total number of conversions by a user.

11. The apparatus of claim 8 wherein the offer server is further for presenting the alternative offer to the user until the alternative threshold has been met.

12. The apparatus of claim 11 wherein the offer server is further for:
presenting the alternative offer to the user until the alternative threshold has been met;
accessing the offer database to identify a second alternative offer and a second alternative threshold;
presenting the second alternative offer to the user; and
incrementing a second counter associated the second alternative threshold.

13. The apparatus of claim 12 wherein second alternative offer is a default offer, the default offer not associated with any threshold.

14. The apparatus of claim 8 wherein the first offer is associated with the alternative offer and the alternative offer represents an enhanced value over the first offer

15. The apparatus of claim 14 further comprising:
determining that the user has declined the alternative offer;
accessing the offer database to identify a second alternative offer associated with and representing enhanced value over the first offer and the alternative offer; and
presenting the second alternative offer to the user.

16. Apparatus comprising a storage medium storing a program having instructions which when executed by a processor will cause the processor to:
access a user identification system to uniquely identify a user;
access an offer database to identify an offer campaign to be presented to the user, the offer campaign including a first offer, a first threshold, an alternative offer and an alternative threshold;
determine that one of the user has declined the first offer and the first threshold has been met with regard to the user;
access the offer database to identify the alternative offer, the alternative offer associated with and representing enhanced value over the first offer, and the associated alternative threshold in the campaign to be presented to the user;
present the alternative offer to the user; and
increment a counter associated with the alternative threshold.

17. The apparatus of claim 16 wherein the first offer is associated with the alternative offer and the alternative offer represents an enhanced value over the first offer

18. The apparatus of claim 16 further comprising:
determining that the user has declined the alternative offer;
accessing the offer database to identify a second alternative offer associated with and representing enhanced value over the first offer and the alternative offer; and
presenting the second alternative offer to the user.
